(19) United States
(12) Patent Application Publication
(10) Pub. No.: US 2023/0130335 A1
(43) Pub. Date: Apr. 27, 2023

(54) SILICON CARBIDE MATRIX COMPOSITE MATERIAL

(71) Applicant: JAPAN FINE CERAMICS CO., LTD., SENDAI-SHI, MIYAGI (JP)

(72) Inventors: Norihito MURAKAWA, SENDAI-SHI, MIYAGI (JP); Sotaro TAKEDA, SENDAI-SHI, MIYAGI (JP); Shin SATO, SENDAI-SHI, MIYAGI (JP); Kazuto SASAKI, SENDAI-SHI, MIYAGI (JP)

(21) Appl. No.: 17/907,828

(22) PCT Filed: Mar. 15, 2021
(86) PCT No.: PCT/JP2021/010446

§ 371 Date: Aug. 29, 2022

(30) Foreign Application Priority Data
Apr. 6, 2020 (JP) 2020-068110

(51) Int. Cl. C04B 35/80; D01F 9/08; D01F 9/22; D01F 9/145

(52) U.S. Cl. CPC C04B 35/80; D01F 9/08; D01F 9/22; D01F 9/145; C04B 2235/383; C04B 2235/3834; C04B 2235/5248; C04B 2235/785; C04B 2235/781; C04B 2235/9607; D10B 2101/08; D10B 2101/16; D10B 2505/02

(57) ABSTRACT

SiC matrix composite material, where heat-resistant long fiber such as carbon fiber is employed as a material for reinforcement and SiC is employed for the matrix, which significantly improves mechanical properties such as strength and toughness. The SiC matrix composite material, includes a SiC matrix and heat-resistant long fiber, wherein the SiC matrix includes both of alpha-type SiC and beta-type SiC, and the alpha-type SiC and the beta-type SiC are detected by micro-region X-ray diffraction with an X-ray beam diameter of no greater than 300 micrometers substantially at every region of every cross-section of the SiC matrix, the beta-type SiC has an average crystallite size that is no greater than 500 nm and greater than an average crystallite size of the alpha-type SiC, and the SiC matrix composite material has a porosity of no greater than 20% by volume.

### FIELD OF THE INVENTION

The present invention relates to a novel SiC (silicon carbide) matrix composite material, more specifically to a fiber-reinforced composite material that contains heat-resistant long fiber as a reinforcing material and also alpha-type SiC as well as beta-type SiC substantially at every micro-region as a matrix and that can exhibit excellent strength characteristics.

### BACKGROUND OF THE INVENTION

The technical purpose of SiC matrix composite materials is said to impart superior high-temperature strength and toughness thereto by strengthening SiC ceramic materials, which have inherent superior heat resistance and high chemical stability, by use of inorganic fibers that are excellent in heat resistance and high temperature strength.

These composite materials are intended to exhibit excellent properties as structural materials for aerospace engines or power generation gas turbines, and also as nuclear fuel cladding tubes, standby-pump bearing members, etc. and are expected to bring about remarkable increase in fuel efficiency, thermal efficiency, and durability etc.

Conventionally, these SiC matrix composite materials have been produced usually by way of initially preparing a two- or three-dimensional preform of inorganic fiber and then forming SiC as the matrix of the preform within the spaces of inorganic fiber.

Various processes have been investigated for forming the SiC matrix; one of the processes is called “chemical vapor infiltration (CVI)”; in which gaseous raw materials including a silane compound such as SiCl₄ and hydrocarbon such as C₃H₈ are fed into a preform to cause a chemical reaction such as pyrolysis thereby forming the SiC matrix in the preform (e.g., see Patent Document 1).

This process may form a SiC matrix having a dense and pure film-like configuration; however, SiC is inevitably synthesized also at spaces outside the preform where SiC-synthesizing conditions are satisfied. As a result, the SiC, which has early been synthesized outside the preform, acts as a barrier that makes essentially difficult to form a dense matrix entirely inside the preform.

Furthermore, this process has a problem in that the resulting matrix of so-called SiC is of amorphous and its atomic ratio of Si to C is not one; that is, the resulting matrix is a substance of non-complete silicon carbide and thus has not the inherent density, hardness, etc. of complete silicon carbide.

Furthermore, a liquid phase infiltration process has been investigated, in which a SiC-precursor polymer is infiltrated and heated to form a SiC ceramic in a preform thereby forming a SiC matrix. However, the SiC precursor remarkably reduces its volume in the stage of transforming to SiC; therefore, the infiltration and heating of batch processing are required many times in order to increase sufficiently the density of SiC matrix (e.g., see Patent Document 2).

No matter how many times the infiltration and heating are repeated, however, dense SiC matrix cannot be produced essentially since the final heating also involves a volume shrinkage. Besides, similarly as above-mentioned, the resulting matrix SiC is of amorphous with an atomic ratio of Si to C not being one and thus has not the inherent density, hardness, etc. of complete SiC.

Furthermore, a melting and infiltration process has been investigated, in which a mixture of SiC powder and carbon powder is infiltrated into a preform, then molten Si mass is injected to cause a reaction therebetween at around 1500 degrees Celsius, thereby forming a SiC matrix. This process may result in a relatively dense structure; however, the resulting structure may be hardly controlled due to a high reaction speed (e.g., see Patent Document 3).

Besides, the resulting SiC matrix of the melting and infiltration process includes a mixture of the initial SiC powder and a reaction product between the carbon powder and the molten Si mass; and the reaction product SiC is beta-type SiC large particles having a particle size of about 1 mm, which are not finely mixed with the initial SiC powder. There also exist unreacted Si and carbon respectively as an agglomeration size of about 1 mm in an amount of at least 10% by mass of the matrix.

Furthermore, a hot press process called NITE (nano-powder infiltration and transient eutectic-phase) has been investigated, in which a SiC super-fine powder with a nano-meter-level particle size and a sintering aid are infiltrated into a preform to form a pre-shaped body and then the body is hot-pressed at higher than 1700 degrees Celsius to sinter the SiC super-fine powder to form a dense SiC matrix (e.g., see Patent Document 4).

This process may result in a less-porous structure and form a beta-type SiC matrix resulting from the SiC super-fine powder sintered by action of the sintering aid such as boron and alumina; however, the indispensable hot-press step leads to problems in that pre-shaped bodies are deformed, preform fibers are damaged, and complex-shaped structural bodies are hard to yield.

In view of these problems, the present inventors have previously proposed a method of producing a SiC matrix composite material, in which a SiC matrix is formed in inner spaces of a preform including a SiC fiber, the method comprises:

a step of depositing a transition metal in the inner spaces of the preform, and a step of bringing a gaseous mixture containing silicon oxide and a carbon compound into contact with the transition metal to synthesize SiC in the inner spaces of the preform while maintaining the preform at a high temperature, thereby forming the SiC matrix in the inner spaces of the preform (e.g., see Patent Document 5).

### PRIOR ART DOCUMENT

### Patent Document

[Patent Document 1]
Japanese Unexamined Patent Application, Publication No. 2015-151587
[Patent Document 2]
Japanese Unexamined Patent Application, Publication No. H11-49570
[Patent Document 3]
Japanese Unexamined Patent Application, Publication No. 2015-212215
[Patent Document 4]
Japanese Unexamined Patent Application, Publication No. 2010-070421
[Patent Document 5]
Japanese Unexamined Patent Application, Publication No. 2019-081648

### BRIEF DESCRIPTION

### Problems to be Solved by the Invention

The present invention remarkably improves the properties of the SiC matrix composite material resulting from the above-mentioned method of the present inventors (see Patent Document 5); particularly, it is an object of the present invention to provide a SiC matrix composite material having remarkably improved mechanical properties in terms of bending strength, fracture toughness and the like.

### Means to Solve the Problems

The purpose of the present invention can be achieved by the SiC matrix composite material, comprising a SiC matrix and heat-resistant long fiber, wherein the SiC matrix comprises both of alpha-type SiC and beta-type SiC, and the alpha-type SiC and the beta-type SiC are detected by micro-region X-ray diffraction with an X-ray beam diameter of no greater than 300 micrometers substantially at every region of every cross-section of the SiC matrix, the beta-type SiC has an average crystallite size that is no greater than 500 nm and greater than an average crystallite size of the alpha-type SiC, and the SiC matrix composite material has a porosity of no greater than 20% by volume.

The SiC matrix composite material of the present invention (hereinafter abbreviated as “the inventive composite material” in this specification) is comprised of heat-resistant fiber such as carbon fiber, SiC fiber and alumina fiber as well as SiC matrix that embeds the spaces between the filaments of the heat-resistant fiber, and the SiC matrix is comprised of crystalline SiC including alpha-type SiC and beta-type SiC.

Furthermore, the alpha-type SiC and the beta-type SiC are detected by micro-region X-ray diffraction with an X-ray beam diameter of no greater than 300 micrometers; such that 10% to 90% by volume of the alpha-type SiC and 90% to 10% by volume of the beta-type SiC are detected substantially at every region of every cross-section of the SiC matrix in the inventive composite material, for example (sum of the alpha-type SiC and the beta-type SiC is 100% by volume).

This indicates that both of alpha-type SiC and beta-type SiC are detected at the same time even in micro-regions with a diameter of no greater than 300 micrometers at randomly-selected every region of every cross-section in the SiC matrix of the inventive composite material, which demonstrates that the alpha-type SiC and the beta-type SiC display an extremely fine mixed condition in the entire SiC matrix.

Furthermore, the beta-type SiC in the SiC matrix of the inventive composite material has an average crystallite size that is no greater than 500 nm and greater than an average crystallite size of the alpha-type SiC, and the inventive composite material has a porosity of no greater than 20% by volume. In this connection, the term “average crystallite size” means the average value of the crystallite size of alpha-type SiC or beta-type SiC that is obtained with respect to the above-noted simultaneous detection of the alpha-type SiC and beta-type SiC substantially at every region of every cross-section of the SiC matrix by way of the micro-region X-ray diffraction.

The present inventors have confirmed experimentally that the inventive composite material exhibits excellent fracture toughness; and the present inventors estimate the reason thereof as follows.

In the field of ceramic material, typically, the larger fracture surface area due to a complex and non-smooth surface exposed by the fracture, that is, to induce a complex fracture surface, is believed to result in higher fracture toughness. In addition, cracks propagating through ceramic material during the material destruction tend to propagate along crystalline grain boundaries rather than across crystalline grains.

It is therefore estimated concerning the inventive composite material that when cracks propagating through the matrix arrive to crystallites of beta-type SiC, the cracks propagate along crystalline grain boundaries rather than across crystalline grains and then arrive to adjacent crystallites of alpha-type SiC, thereafter propagating along crystalline grain boundaries of the crystallites.

It is also estimated that when the beta-type SiC has an average crystallite size that is no greater than 500 nm and greater than an average crystallite size of the alpha-type SiC, propagation stoppage and bending of cracks are promoted, and when the porosity is no greater than 20% by volume, enlarging of cracks is suppressed, consequently complex fracture surfaces are induced in the SiC matrix.

In this way, the cracks propagating within the matrix in the inventive composite material may be divided finely since the matrix is comprised of finely co-existing alpha-type SiC and beta-type SiC with a certain volume percentage and crystallite size, consequently the fracture toughness of the inventive composite material is enhanced.

It is preferred in the inventive composite material that the alpha-type SiC has an average crystallite size of from 5 to 200 nm, the beta-type SiC has an average crystallite size of from 10 to 500 nm, the average crystallite size of the beta-type SiC is no less than two times of the average crystallite size of the alpha-type SiC, and the SiC matrix composite material has a porosity of no greater than 15% by volume. The inventive composite material, having these properties, may exhibit more excellent mechanical properties in terms of bending strength, toughness and the like.

### Effect of the Invention

The SiC matrix composite material, where heat-resistant long fiber such as carbon fiber, SiC fiber and alumina fiber is employed as a material for reinforcement and SiC is employed for the matrix, is significantly improved with respect to mechanical properties such as strength and toughness.

### BRIEF DESCRIPTION OF THE DRAWINGS

FIG. 1 is a view schematically exemplifying an apparatus used for producing the SiC matrix composite material of the present invention; and

FIG. 2 shows a scanning electron microscope (SEM) image of a polished cross-section of the SiC matrix composite material of the present invention.

### DETAILED DESCRIPTION OF THE INVENTION

The SiC matrix composite material of the present invention comprises a SiC matrix and heat-resistant long fiber, wherein the SiC matrix comprises both of alpha-type SiC and beta-type SiC, and the alpha-type SiC and the beta-type SiC are detected by micro-region X-ray diffraction with an X-ray beam diameter of no greater than 300 micrometers substantially at every region of every cross-section of the SiC matrix, the beta-type SiC has an average crystallite size that is no greater than 500 nm and greater than an average crystallite size of the alpha-type SiC, and the SiC matrix composite material has a porosity of no greater than 20% by volume.

In this connection, the heat-resistant long fiber may be exemplified by heat-resistant continuous long fiber such as carbon fiber, SiC fiber and alumina fiber with a filament diameter of from several micrometers to several ten micrometers.

The SiC matrix intervenes between and fixes the long filaments of the heat resistant long fiber that contributes as a reinforcing material, and thus the combination of the SiC matrix and the heat resistant long fiber acts as a high-strength heat-resistant material;

for example, the combination of the SiC matrix of from 20% to 80% by volume and the heat resistant long fiber of from 80% to 20% by volume functions as a high-strength heat-resistant material (total volume content of the SiC matrix and the heat resistant long fiber is 100% by volume);

In this embodiment, the SiC matrix composite material comprises the SiC matrix of from 20% to 80% by volume and the heat resistant long fiber of from 80% to 20% by volume, the SiC matrix comprises both of alpha-type SiC and beta-type SiC, and the alpha-type SiC and the beta-type SiC are detected by micro-region X-ray diffraction with an X-ray beam diameter of no greater than 300 micrometers substantially at every region of every cross-section of the SiC matrix, the beta-type SiC has an average crystallite size that is no greater than 500 nm and greater than an average crystallite size of the alpha-type SiC, and the SiC matrix composite material has a porosity of no greater than 20% by volume.

In a representative embodiment, the SiC matrix of the inventive composite material comprises the alpha-type SiC of from 10% to 90% by volume and the beta-type SiC of from 90% to 10% by volume. The total volume content of alpha-type SiC and beta-type SiC is 100% by volume. The alpha-type SiC has a hexagonal crystal structure with various polytypes such as 4H, 6H and 15R. The beta-type SiC has a cubic crystal structure with only one polytype of 3C.

In the inventive composite material, the alpha-type SiC of from 10% to 90% by volume and the beta-type SiC of from 90% to 10% by volume may be detected by micro-region X-ray diffraction with an X-ray beam diameter of no greater than 300 micrometers at substantially every region of substantially every cross-section of the SiC matrix.

In the present invention, the term “substantially every cross-section” is defined as “at least 90% of the cross-sections expressed as a numerical ratio” based on many cross-sections exposed at random in the SiC matrix composite material. Furthermore, “substantially every region” is defined as “at least 90% of the regions expressed as a numerical ratio” based on many regions selected at random within the cross-sections. In this connection, the sampling density for the detection may be within the range of from 5 cm⁻² to 100 cm⁻² of the SiC matrix composite material, for example.

That is, existence of alpha-type SiC and beta-type SiC can be detected by micro-region X-ray diffraction at regions selected at random within cross-sections selected at random in the inventive composite material.

Here, as well known by those skilled in the art, the “micro-region X-ray diffraction” is a specific X-ray diffraction method where X-rays are irradiated to a crystalline substance to measure X-rays diffracted by crystal lattices thereby to take information of crystal structure of the substance, in which beam size of irradiating X-rays is narrowed down using a collimator thereby to limit the region where X-rays are irradiated and diffracted into an intended size of micro-region.

Specifically, X-rays narrowed down using a collimator with a pore diameter of no greater than 300 micrometers are irradiated and diffracted at cross-sections of SiC matrices, and preferably the diffracted X-rays are measured using a two-dimensional detector. It is also preferred for improving measurement accuracy that angular velocity of X-ray irradiating goniometers is set low as possible and cross-sections of SiC matrices are polished prior to X-ray irradiation into a surface roughness of no greater than 10 micrometers.

The above-noted micro-region X-ray diffraction can be carried out, as well known by those skilled in the art, using a commercially available X-ray diffraction apparatus; and collimators for narrowing down the X-rays irradiating the samples to be measured into a beam diameter of 300, 200, 100, 50 or 30 micrometers etc. are also commercially available.

X-ray diffraction data of SiC matrix of the inventive composite material can also be taken using the X-ray diffraction apparatuses with such collimators.

From the X-ray diffraction data obtained using the X-ray diffraction apparatuses, subsequently, the existence ratios of alpha-type SiC and beta-type SiC in the SiC matrix can be calculated, as well known by those skilled in the art, using Rietveld method; and also each diffraction pattern of alpha-type SiC and beta-type SiC can be derived. Then, from the diffraction patterns and diffraction data, each crystallite size of alpha-type SiC and beta-type SiC can be computed using Williamson-Hall method, for example.

That is, the existence ratio of alpha-type SiC and beta-type SiC can be measured for each micro-region and also each crystallite size of alpha-type SiC and beta-type SiC can be calculated; as such, based on the micro-region X-ray diffraction data collected at many micro-regions, the “average crystallite size” of the present invention can be directed by way of averaging many average crystallite sizes of alpha-type SiC and beta-type SiC resulting as explained above in detail.

It should be noted in cases that there exist filaments of the heat-resistant fiber in addition to SiC matrix at a micro-region where X-rays are irradiated, the contribution of X-rays deflected by the heat-resistant fiber on the diffraction data for measuring the existence ratios of alpha-type SiC and beta-type SiC can be excluded as described below and then the Rietveld method can be applied.

The above-noted contribution on the diffraction data can be removed by way of collecting diffraction data from the heat-resistant fiber itself in advance, and subtracting the contribution of the heat-resistant fiber on the data from the measured diffraction data, on the base of the content ratio of the filaments of the heat-resistant fiber that can be calculated from the cross-section image of the micro-region taken by a microscope.

In this way, whether or not satisfying the specific matter of the above-noted exemplary embodiment “the alpha-type SiC of from 10% to 90% by volume and the beta-type SiC of from 90% to 10% by volume may be detected by micro-region X-ray diffraction with an X-ray beam diameter of no greater than 300 micrometers at substantially every region of substantially every cross-section of the SiC matrix” can be decided by way of taking diffraction data using an X-ray diffraction apparatus with a collimator having a pore diameter of no greater than 300 micrometers and applying the Rietveld method and the Williamson-Hall method.

The above-noted inventive composite material can be produced by a method that improves the method (see Patent Document 5) proposed in advance by the inventors of the present invention.

Specifically, the method of producing the inventive composite material comprises forming a SiC powder-containing preform by use of a heat-resistant fiber bundle bearing a SiC powder, then disposing the preform within a heating space and forming a SiC matrix between filaments of heat-resistant fibers, in which a carbon compound and silicon oxide are supplied from outside of the preform into inner spaces of the preform where the SiC powder, the heat-resistant fiber and a transition metal exist, and SiC is generated from the carbon compound of C source and the silicon oxide of Si source by a catalytic action of the transition metal under high temperatures, thereby embedding the inner spaces of the preform with SiC.

In this connection, the SiC powder has an alpha-type crystal structure and is supported with a transition metal before being heated in the heating space; and the carbon compound and silicon oxide are supplied into the heating space while heating the preform disposed in the heating space to from 1300 to 1600 degrees Celsius, preferably from 1400 to 1500 degrees Celsius, thereby beta-type SiC is formed at inner spaces of the preform by the catalytic action of the transition metal.

The transition metal can be supported on the alpha-type SiC powder by way of preparing a solution of a compound of the transition metal, dipping the alpha-type SiC powder into the solution, and heat drying the solvent of the solution, for example. The solution of the compound of the transition metal may be appropriately selected from the group consisting of aqueous solutions and organic solvent solutions of nitrates, hydrochlorides, carbonates, and organic metal compounds of the transition metal, etc.

The carried transition metal existing in the preform may be in the original form of nitrates, hydrochlorides, carbonates, sulfates, phosphates, oxides, chlorides, or various organic compounds of the transition metal until heated in the heating space; alternatively the carried transition metal may be transformed into an oxide of the transition metal by heating in an air atmosphere at several hundred degrees Celsius.

The amount of the transition metal existing as above-noted form in the preform is preferably from 0.1% to 5% by mass, more preferably from 0.2% to 1% by mass as the transition metal itself based on the preform mass.

The catalytic effect of the transition metal contemplated by the inventors of the present invention is that the transition metal reduces the gaseous silicon oxide to thereby fix the silicon in a solid or liquid condition, and the fixed silicon reacts with the carbon compound to generate SiC in site.

The reaction proceeds to generate beta-type SiC at the calcination temperature of even from 1300 to 1600 degrees Celsius that is lower than the temperature at which silicon oxide and carbon compounds can directly react to generate SiC without catalytic effect, therefore beta-type SiC can be formed substantially only at the positions of the catalyst at inner spaces of the preform.

As a result, without changing the crystal form of the existing alpha-type SiC powder, beta-type SiC can be formed at positions of the catalyst carried on the alpha-type SiC powder, i.e. the positions adjacent to the alpha-type SiC powder. Here, the particle size of the alpha-type SiC powder is preferably from 0.01 to 5 micrometers, more preferably from 0.1 to 2 micrometers.

It has additionally been confirmed that crystallite size and particle size of the alpha-type SiC powder are also maintained along with the crystal form at the calcination temperature of from 1300 to 1600 degrees Celsius; on the other hand, the generating beta-type SiC has typically a larger crystallite size as the calcination temperature is higher, and tends to increase as the calcination period is longer and/or additive amount of the catalytic transition metal is larger.

Considering these matters, the SiC matrix containing the beta-type SiC having an average crystallite size of no greater than 500 nm and greater than an average crystallite size of the alpha-type SiC as defined in the present invention can be formed by selecting an alpha-type SiC powder with an appropriate particle size and a crystallite size and also properly selecting calcinating temperature and period.

In addition, the above-noted method of supplying a carbon compound and silicon oxide from outside the preform and forming SiC inside the preform by the catalytic action under high temperatures is appropriate for producing a SiC matrix composite material having a porosity of no greater than 20% by volume required in the inventive composite material.

The reason is in particular that the reaction of forming SiC does not substantially proceed outside the preform where no catalyst exist, consequently there is no problem that priorly formed SiC comes to a barrier for remaining inner spaces and greatly disturbs to decrease the porosity as conventional chemical vapor infiltration processes (see Patent Document 1).

Here, the above-noted process “forming a SiC powder-containing preform by use of a heat-resistant fiber bundle bearing a SiC powder” explained in producing the inventive composite material may be exemplified by immersing the heat-resistant fiber bundle into a slurry containing an alpha-type SiC powder and pulling out therefrom thereby to make the heat-resistant fiber bundle bear the alpha-type SiC powder, then the resulting heat-resistant fiber bundle is shaped into an intended preform, as a preferable embodiment.

In accordance with the above-noted process, alpha-type SiC powders can be attached effectively on heat-resistant fiber bundles each consisting of filaments as many as several hundreds to several thousands; in addition, the present inventors believe that the alpha-type SiC powders are valuable also by the reason below.

The ideal structural configuration of the heat-resistant fiber and SiC matrix in the inventive composite material will be that the SiC matrix exists around each filament of the heat-resistant fiber. However, when a preform is shaped from a fiber bundle where many filaments are tied up, the preform is likely to be an agglomeration of a great number of filament bundles; therefore, the flow paths for reaching the circumferences of each of the filaments will be respectively narrow and long for the gaseous mixture of the silicon oxide and carbon compounds.

On the other hand, when the heat-resistant fiber bundle has been attached with an alpha-type SiC powder in advance, voids between fiber bundles tend to be decreased in the preform and also close contact between filaments tends to be disturbed since particles of the powder may intervene between the filaments. In addition, the transition metal with catalytic effect has been carried on the alpha-type SiC powder and thus each particle of the powder may be a site of generating beta-type SiC, consequently numerous sources of SiC matrix can be assured in each heat-resistant fiber bundle.

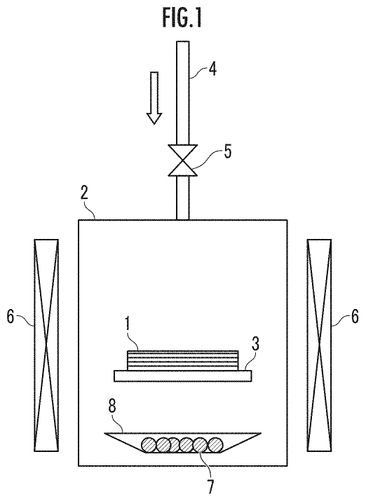

FIG. 1 exemplarily shows an embodiment of an apparatus used for producing the SiC matrix composite material of the present invention. A preform 1 containing an alpha-type SiC powder and a heat-resistant fiber bundle carried with a transition metal is placed on the table 3 within the vacuum chamber 2. Granular silicon oxide 7 is disposed on the pan container 8 at an under side in the vacuum chamber 2 and the granular silicon oxide 7 is fed from outside along with heating time. A carbon compound is supplied through the flow passage 4; and the flow rate of the carbon compound is adjusted using the valve 5.

In this way, the vacuum chamber 2 is heated by use of the heater 6 to sublimate the silicon oxide 7 gradually while supplying the carbon compound for a predetermined period, thereby the atmosphere in the vacuum chamber 2 becomes a gas phase mixture including silicon oxide and the carbon compound, and which can generate beta-type SiC adjacent to alpha-type SiC within inner spaces of the preform 1, consequently the SiC matrix composite material can be produced.

Here, FIG. 1 shows an exemplary producing apparatus used for the method of producing the inventive composite material only in a conceptual manner, thus shapes and dimensional ratios thereof do not necessarily coincide with actual ones.

As described above in detail, the present invention is a SiC matrix composite material comprising a SiC matrix that includes both of alpha-type SiC and beta-type SiC and has a specific microstructure.

The inventive composite material is definitely different from the above-explained conventional composite materials of the chemical vapor infiltration process (see Patent Document 1) and the liquid phase infiltration process (see Patent Document 2) in that SiC matrix of the latters is of amorphous rather than crystalline as well as of incomplete-substance SiC where the atomic ratio Si/C is not necessarily one, and the porosities of composite materials of latters are considerably greater than 20% by volume.

Furthermore, the SiC matrix resulting from the above-described melting and infiltration process (see Patent Document 3) is definitely different from that of the inventive composite material in that the SiC matrix represents a mixture of carbon powder, large particles of silicon, and beta-type SiC with particle diameters of around 1 mm.

Furthermore, the SiC matrix resulting from the above-described nano-powder infiltration and transient eutectic-phase process (see Patent Document 4) is definitely different from that of the inventive composite material in that the SiC matrix consists of beta-type SiC obtained by sintering at above 1700 degrees Celsius with a sintering aid and also the crystallite size greatly exceeds 500 nm defined in the present invention.

Here, provided that the matrix of beta-type SiC is heated further to as high as above 1800 degrees Celsius, the SiC matrix may cause a crystal change partially from beta-type to alpha-type and thus may have both of alpha-type and beta-type crystal structure. However, the present inventors have confirmed experimentally that the SiC matrix heated to above 1800 degrees Celsius includes alpha-type SiC and beta-type SiC both of which crystallite sizes are greater than 500 nm and represents remarkably low fracture toughness.

### EXAMPLES

### Example 1

A PAN-type carbon fiber bundle consisting of 1000 continuous monofilaments (diameter: 7 micrometers) was immersed into a 10% by mass aqueous solution of nickel(II) acetate (Ni(CH₃COO)₂. 4H₂O) while being pulled out from a bobbin, and then was continuously passed through an atmospheric electric furnace at 450 degrees Celsius, thereby to prepare the fiber bundle carried with nickel oxide where the fiber bundle bore 1 part by mass of nickel oxide per 100 parts by mass of the carbon fiber bundle.

On the other hand, a SiC powder (specific surface area: 18 m²/g, average particle size: 0.31 micrometer) having an alpha-type crystal structure was mixed with 10% by mass aqueous solution of nickel(II) acetate and dried and then heated to 500 degrees Celsius in the air, thereby obtaining the SiC powder where 1 part by mass of nickel oxide was carried on 100 parts by mass of the alpha-type SiC powder.

The alpha-type SiC powder carried with nickel oxide was dispersed into water to make a slurry (mass ratio: powder/water=1/2), then the above-noted carbon fiber bundle carried with nickel oxide was continuously immersed into and pulled out from the slurry and the carbon fiber bundle bearing the alpha-type SiC powder was successively reeled on a winding machine.

In this connection, a graphite plate of 50 mm long by 30 mm wide by 5 mm thick was attached to a winding part of the winding machine; then the graphite plate was rotated and the rotating shaft thereof was moved simultaneously, thereby the PAN type carbon fiber bundle bearing the alpha-type SiC powder was wound onto both sides of the graphite plate along the longitudinal direction up to 1 mm thick. Consequently, a preform of 52 mm long by 30 mm wide by 7 mm thick was obtained, which was comprised of the graphite plate, the alpha-type SiC powder carried with nickel oxide, and the carbon fiber bundle carried with nickel oxide.

Next, using the apparatus for producing a SiC matrix composite material shown in FIG. 1, the resulting preform 1 was placed on the table 3 and ten grams of granular silicon monoxide was poured into the pan container 8, then air within the vacuum chamber 2 was exchanged for argon and the temperature in the vacuum chamber 2 was raised to 1425 degrees Celsius by energizing the heater 6.

Then, propane (C₃H₈) gas was supplied through the flow passage 4 in a flow rate of 300 mL/h into the vacuum chamber 2; on the other hand, silicon monoxide was supplied through an air-block inlet (not shown) in a rate of one gram per each one hour onto the pan container 8. Under these conditions, the preform was calcined at 1425 degrees Celsius for 50 hours, followed by allowing to cool and taking out.

The original size of 52 mm long by 30 mm wide by 7 mm thick of the preform was maintained after the calcination, SiC was synthesized within inner spaces of the carbon fiber bundles, and the carbon bundles were consolidated into a plate. Then the calcined preform of the plate was shortened to 40 mm long by cutting out each 6 mm from the both longitudinal edges, and the plates of the consolidated carbon bundles were separated from the graphite plate, thereby obtaining two plates of each 40 mm long by 30 mm wide by 1 mm thick of SiC matrix composite material. The resulting SiC matrix composite material was comprised of 39% by volume of SiC matrix, 45% by volume of the carbon fiber, and 16% by volume of porosity.

The two pieces of the SiC matrix composite material were subjected to 3-point bending strength test; consequently the bending strength was 980 MPa in average. In the bending strength test, the SiC matrix composite material was disposed such that the extending direction of the carbon fiber was perpendicular to the longitudinal direction of the pressing bar, the distance between the supports was 30 mm, and the lowering velocity of the pressing bar was 1 mm/minute. Furthermore, the fracture toughness value of the SiC matrix composite material was 18 MPa·m^{1/2} based on the 3-point bending strength test.

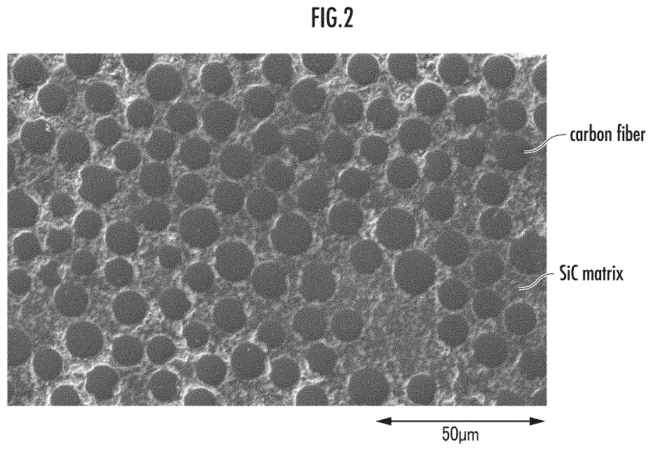

FIG. 2 shows a scanning electron microscope (SEM) image of a polished cross-section of the above-mentioned SiC matrix composite material, in which the polished cross-section was prepared by means that the resulting SiC matrix composite material was cut perpendicularly to the extending direction of the carbon fiber and the exposed cross-section was polished precisely including buff polishing.

Then, the SiC matrix composite material was measured quantitatively for volume fractions and crystallite sizes of alpha-type SiC and beta-type SiC using micro-region X-ray diffraction. Specifically, the SiC matrix composite material was cut in random directions to expose cross-sections thereof, then which were polished precisely including buff polishing to prepare 10 cross-sections thereof with a surface roughness of no greater than 2 micrometers.

From each cross-section, 10 micro-region sites were randomly selected to confirm whether the content of SiC matrix was rich there while observing the positions of the carbon fiber and SiC matrix, and 100 sites were determined in total as the micro-regions for X-ray diffraction. Then, these 100 micro-regions of the matrix were evaluated and analyzed for crystal morphology by use of an X-ray diffraction equipment (SmartLab, by Rigaku Corporation) equipped with a two-dimensional detector.

Cu-Kα rays generated at tube voltage 45 kV and tube current 200 mA were used as the diffraction X-rays; a collimator with a pore diameter of 100 micrometers was placed between the X-ray generator and each sample of the composite material; and measurement conditions were 10 degrees of measurement start position, 80 degrees of measurement finish position, 0.050 degree of step width, and 5.0 seconds of counting time.

In this way, X-ray diffraction data were collected from the 100 micro-regions of the matrix, then 100 existence ratios of alpha-type SiC and beta-type SiC were derived using Rietveld method, and 100 crystallite sizes of alpha-type SiC and beta-type SiC were also derived using Williamson-Hall method.

Here, in cases where a PAN type carbon fiber was also detected at any one or more 100 micro-regions by the X-ray diffraction in addition to SiC matrix, the effect of the PAN type carbon fiber on the resulting diffraction data could be eliminated from the diffraction data by use of a data processing program, which could take in priorly collected diffraction data of the PAN type carbon fiber itself as well as the content ratio of the PAN type carbon fiber that could be calculated from the microscope images of the cross-sections of the micro-regions.

As a result of the X-ray diffraction data for 100 micro-regions determined in this way, alpha-type SiC of from 10% to 90% by volume and beta-type SiC of from 90% to 10% by volume were detected at all 100 micro-regions, the mean content of the alpha-type SiC was 45% by volume (maximum: 74% by volume, minimum: 28% by volume), and the mean content of the beta-type SiC was 55% by volume (maximum: 72% by volume, minimum: 26% by volume).

As for the 100 micro-regions also, the beta-type SiC had an average crystallite size of 233 nm (maximum: 483 nm, minimum: 110 nm), and the alpha-type SiC had an average crystallite size of 92 nm (maximum: 145 nm, minimum: 51 nm).

### Example 2

In a similar manner to Example 1, a PAN-type carbon fiber bundle consisting of 1000 continuous monofilaments (diameter: 7 micrometers) carried with 1 part by mass of nickel oxide per 100 parts by mass of the carbon fiber bundle was prepared; on the other hand, preparing a SiC powder (specific surface area: 15 m²/g, average particle size: 0.37 micrometer) having an alpha-type crystal structure and carried with 1 part by mass of nickel oxide per 100 parts by mass of the alpha-type SiC powder.

Then in a similar manner to Example 1, the carbon fiber bundle bearing the alpha-type SiC powder was reeled on a winding machine; consequently obtaining a preform of 52 mm long by 30 mm wide by 7 mm thick, which was comprised of the graphite plate, the alpha-type SiC powder carried with nickel oxide, and the carbon fiber bundle carried with nickel oxide.

Next, using the apparatus for producing a SiC matrix composite material shown in FIG. 1 in a similar manner to Example 1, two plates of each 40 mm long by 30 mm wide by 1 mm thick of SiC matrix composite material were obtained. The resulting SiC matrix composite material was comprised of 38% by volume of SiC matrix, 45% by volume of the carbon fiber, and 17% by volume of porosity.

The two pieces of the SiC matrix composite material were subjected to 3-point bending strength test; consequently the bending strength was 990 MPa in average. Furthermore, the fracture toughness value of the SiC matrix composite material was 17 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology by means of micro-region X-ray diffraction in a similar manner to Example 1 except for using a collimator with a pore diameter of 200 micrometers.

As a result, alpha-type SiC of from 10% to 90% by volume and beta-type SiC of from 90% to 10% by volume were detected at all 100 micro-regions of the SiC matrix, the mean content of the alpha-type SiC was 47% by volume (maximum: 79% by volume, minimum: 23% by volume), and the mean content of the beta-type SiC was 53% by volume (maximum: 67% by volume, minimum: 21% by volume).

As for the 100 micro-regions also, the beta-type SiC had an average crystallite size of 314 nm (maximum: 502 nm, minimum: 141 nm), and the alpha-type SiC had an average crystallite size of 108 nm (maximum: 146 nm, minimum: 41 nm).

### Example 3

In a similar manner to Example 1, a PAN-type carbon fiber bundle consisting of 1000 continuous monofilaments (diameter: 7 micrometers) carried with 1 part by mass of nickel oxide per 100 parts by mass of the carbon fiber bundle was prepared; on the other hand, preparing a SiC powder (specific surface area: 10 m²/g, average particle size: 0.56 micrometer) having an alpha-type crystal structure and carried with 1 part by mass of nickel oxide per 100 parts by mass of the alpha-type SiC powder.

Then in a similar manner to Example 1, the carbon fiber bundle bearing the alpha-type SiC powder was reeled on a winding machine; consequently obtaining a preform of 52 mm long by 30 mm wide by 7 mm thick, which was comprised of the graphite plate, the alpha-type SiC powder carried with nickel oxide, and the carbon fiber bundle carried with nickel oxide.

Next, using the apparatus for producing a SiC matrix composite material shown in FIG. 1 in a similar manner to Example 1, two plates of each 40 mm long by 30 mm wide by 1 mm thick of SiC matrix composite material were obtained. The resulting SiC matrix composite material was comprised of 41% by volume of SiC matrix, 45% by volume of the carbon fiber, and 14% by volume of porosity.

The two pieces of the SiC matrix composite material were subjected to 3-point bending strength test; consequently the bending strength was 1020 MPa in average. Furthermore, the fracture toughness value of the SiC matrix composite material was 19 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology by means of micro-region X-ray diffraction in a similar manner to Example 1 except for using a collimator with a pore diameter of 300 micrometers.

As a result, alpha-type SiC of from 10% to 90% by volume and beta-type SiC of from 90% to 10% by volume were detected at all 100 micro-regions of the SiC matrix, the mean content of the alpha-type SiC was 48% by volume (maximum: 81% by volume, minimum: 25% by volume), and the mean content of the beta-type SiC was 52% by volume (maximum: 75% by volume, minimum: 19% by volume).

As for the 100 micro-regions of the matrix also, the beta-type SiC had an average crystallite size of 252 nm (maximum: 332 nm, minimum: 78 nm), and the alpha-type SiC had an average crystallite size of 92 nm (maximum: 181 nm, minimum: 39 nm).

### Example 4

In the same manner as Example 1 except for using a pitch type carbon fiber bundle consisting of 3000 continuous monofilaments (diameter: 10 micrometers) in place of the PAN-type carbon fiber bundle consisting of 1000 continuous monofilaments (diameter: 7 micrometers), two plates of each 40 mm long by 30 mm wide by 1 mm thick of SiC matrix composite material were obtained.

The resulting SiC matrix composite material was comprised of 33% by volume of SiC matrix, 50% by volume of the carbon fiber, and 17% by volume of porosity.

The two pieces of the SiC matrix composite material were subjected to 3-point bending strength test; consequently the bending strength was 920 MPa in average. Furthermore, the fracture toughness value of the SiC matrix composite material was 20 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology means of micro-region X-ray diffraction in the same manner as Example 1 using a collimator with a pore diameter of 50 micrometers.

As a result, alpha-type SiC of from 10% to 90% by volume and beta-type SiC of from 90% to 10% by volume were detected at all 100 micro-regions of the SiC matrix, the mean content of the alpha-type SiC was 56% by volume (maximum: 81% by volume, minimum: 29% by volume), and the mean content of the beta-type SiC was 44% by volume (maximum: 71% by volume, minimum: 19% by volume).

As for the 100 micro-regions also, the beta-type SiC had an average crystallite size of 439 nm (maximum: 595 nm, minimum: 104 nm), and the alpha-type SiC had an average crystallite size of 195 nm (maximum: 310 nm, minimum: 128 nm).

### Comparative Example 1

In a similar manner to Example 1, a PAN-type carbon fiber bundle consisting of 1000 continuous monofilaments (diameter: 7 micrometers) carried with 1 part by mass of nickel oxide per 100 parts by mass of the carbon fiber bundle was prepared; on the other hand, preparing a SiC powder (specific surface area: 17 m²/g, average particle size: 0.33 micrometer) having a beta-type crystal structure and carried with 1 part by mass of nickel oxide per 100 parts by mass of the beta-type SiC powder.

Then in a similar manner to Example 1, the carbon fiber bundle bearing the beta-type SiC powder was reeled on a winding machine; consequently obtaining a preform of 52 mm long by 30 mm wide by 7 mm thick, which was comprised of the graphite plate, the beta-type SiC powder carried with nickel oxide, and the carbon fiber bundle carried with nickel oxide.

Next, using the apparatus for producing a SiC matrix composite material shown in FIG. 1 in a similar manner to Example 1, two plates of each 40 mm long by 30 mm wide by 1 mm thick of SiC matrix composite material were obtained. The resulting SiC matrix composite material was comprised of 53% by volume of SiC matrix, 29% by volume of the carbon fiber, and 18% by volume of porosity. The two pieces of the SiC matrix composite material were subjected to 3-point bending strength test; consequently the bending strength was 910 MPa in average. Furthermore, the fracture toughness value of the SiC matrix composite material was 12 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers. These cross-sections were evaluated and analyzed for crystal morphology by means of micro-region X-ray diffraction in the same manner as Example 1 using a collimator with a pore diameter of 100 micrometers. As a result, beta-type SiC was exclusively detected at all 100 micro-regions of the SiC matrix, and as for the 100 micro-regions also, the beta-type SiC had an average crystallite size of 430 nm (maximum: 610 nm, minimum: 89 nm).

### Comparative Example 2

In a similar manner to Example 1, a PAN-type carbon fiber bundle consisting of 1000 continuous monofilaments (diameter: 7 micrometers) carried with 1 part by mass of nickel oxide per 100 parts by mass of the carbon fiber bundle was prepared; on the other hand, preparing a SiC powder (specific surface area: 5 m²/g, average particle size: 1.2 micrometers) having an alpha-type crystal structure and carried with 1 part by mass of nickel oxide per 100 parts by mass of the alpha-type SiC powder.

Then in a similar manner to Example 1, the carbon fiber bundle bearing the alpha-type SiC powder was reeled on a winding machine; consequently obtaining a preform of 52 mm long by 30 mm wide by 7 mm thick, which was comprised of the graphite plate, the alpha-type SiC powder carried with nickel oxide, and the carbon fiber bundle carried with nickel oxide.

Next, using the apparatus for producing a SiC matrix composite material shown in FIG. 1 in the same manner as Example 1 except for calcinating the preform at 1350 degrees Celsius for 50 hours, two plates of each 40 mm long by 30 mm wide by 1 mm thick of SiC matrix composite material were obtained.

The resulting SiC matrix composite material was comprised of 52% by volume of SiC matrix, 33% by volume of the carbon fiber, and 15% by volume of porosity. The two pieces of the SiC matrix composite material were subjected to 3-point bending strength test; consequently the bending strength was 890 MPa in average. Furthermore, the fracture toughness value of the SiC matrix composite material was 11 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers. These cross-sections were evaluated and analyzed for crystal morphology by Means of micro-region X-ray diffraction in the same manner as Example 1 using a collimator with a pore diameter of 100 micrometers.

As a result, alpha-type SiC was exclusively detected at 6 micro-regions among 100 micro-regions of the SiC matrix; the mean content of the alpha-type SiC was 55% by volume (maximum: 100% by volume, minimum: 35% by volume), and the mean content of the beta-type SiC was 45% by volume (maximum: 65% by volume, minimum: 0% by volume).

As for the 100 micro-regions also, the beta-type SiC had an average crystallite size of 155 nm (maximum: 210 nm, minimum: 0 nm), and the alpha-type SiC had an average crystallite size of 880 nm (maximum: 1550 nm, minimum: 425 nm).

### Example 5

In the same manner as Example 1 except for using a SiC fiber bundle consisting of 500 continuous monofilaments (diameter: 12 micrometers) in place of the PAN-type carbon fiber bundle consisting of 1000 continuous monofilaments (diameter: 7 micrometers) and using the SiC powder (specific surface area: 18 m²/g, average particle size: 0.31 micrometer) having an alpha-type crystal structure, two plates of each 40 mm long by 30 mm wide by 1 mm thick of SiC matrix composite material were obtained.

The resulting SiC matrix composite material was comprised of 53% by volume of SiC matrix, 31% by volume of the SiC fiber, and 16% by volume of porosity.

The two pieces of the SiC matrix composite material were subjected to 3-point bending strength test; consequently the bending strength was 960 MPa in average. Furthermore, the fracture toughness value of the SiC matrix composite material was 17 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology b means of micro-region X-ray diffraction in the same manner as Example 1 using a collimator with a pore diameter of 200 micrometers.

As a result, alpha-type SiC of from 10% to 90% by volume and beta-type SiC of from 90% to 10% by volume were detected at all 100 micro-regions of the SiC matrix, the mean content of the alpha-type SiC was 39% by volume (maximum: 63% by volume, minimum: 12% by volume), and the mean content of the beta-type SiC was 61% by volume (maximum: 88% by volume, minimum: 37% by volume).

As for the 100 micro-regions also, the beta-type SiC had an average crystallite size of 366 nm (maximum: 435 nm, minimum: 89 nm), and the alpha-type SiC had an average crystallite size of 172 nm (maximum: 302 nm, minimum: 106 nm).

### Comparative Example 3

Using a SiC fiber bundle consisting of 500 continuous monofilaments (diameter: 12 micrometers) in a similar manner to Example 5 and also using an alpha-type SiC powder having a relatively large particle size (specific surface area: 0.6 m²/g, average particle size: 5.3 micrometers), two plates of each 40 mm long by 30 mm wide by 1 mm thick of SiC matrix composite material were obtained.

The resulting SiC matrix composite material was comprised of 41% by volume of SiC matrix, 34% by volume of the SiC fiber, and 25% by volume of porosity.

The two pieces of the SiC matrix composite material were subjected to 3-point bending strength test; consequently the bending strength was 900 MPa in average. Furthermore, the fracture toughness value of the SiC matrix composite material was 10 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology by means of micro-region X-ray diffraction in the same manner as Example 1 using a collimator with a pore diameter of 200 micrometers.

As a result, alpha-type SiC was exclusively detected at 12 micro-regions among 100 micro-regions of the SiC matrix; the mean content of the alpha-type SiC was 44% by volume (maximum: 100% by volume, minimum: 9% by volume), and the mean content of the beta-type SiC was 56% by volume (maximum: 91% by volume, minimum: 0% by volume).

As for the 100 micro-regions also, the beta-type SiC had an average crystallite size of 313 nm (maximum: 471 nm, minimum: 141 nm), and the alpha-type SiC had an average crystallite size of 991 nm (maximum: 2050 nm, minimum: 504 nm).

### Comparative Example 4

The nano-powder infiltration and transient eutectic-phase process (see Patent Document 4) was followed in this experiment.

In the same manner as Example 1 except for using a SiC fiber bundle consisting of 500 continuous monofilaments (diameter: 12 micrometers) and also using a super fine SiC powder (amorphous crystal structure, specific surface area: 54 m²/g, average particle size: 50 nm) added with a fine alumina powder of 5% by mass as a sintering aid, a preform of 52 mm long by 30 mm wide by 7 mm thick was obtained, which was comprised of the graphite plate, the super fine SiC powder, and the SiC fiber bundle.

The preform was placed in a hot-pressing machine and heated at 1780 degrees Celsius for 2 hours while uniaxially pressing both sides of the preform of each 52 mm long by 30 mm wide under argon atmosphere. The hot-pressed preform had deformed into 52 mm long by 30 mm wide by 5 mm thick, and the super fine SiC powder had sintered and consolidated into a plate along with the SiC monofilaments. Then the plate was shortened to 40 mm long by cutting out each 6 mm from the both longitudinal edges, and the graphite plate was separated, thereby obtaining two plates of each 40 mm long by 30 mm wide by 0.7 mm thick of SiC matrix composite material.

The resulting SiC matrix composite material was comprised of 41% by volume of SiC matrix, 47% by volume of the SiC fiber, and 12% by volume of porosity.

The two pieces of the SiC matrix composite material were subjected to 3-point bending strength test; consequently the bending strength was 760 MPa in average. Furthermore, the fracture toughness value of the SiC matrix composite material was 7 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology by means of micro-region X-ray diffraction in the same manner as Example 1 using a collimator with a pore diameter of 200 micrometers. As a result, beta-type SiC was exclusively detected at 100 micro-regions of the SiC matrix, and the average crystallite size was 1892 nm (maximum: 2610 nm, minimum: 589 nm).

Furthermore, the SiC matrix composite material of which matrix consisting of beta-type SiC was heated at 1900 degrees Celsius for 2 hours under argon atmosphere, then was evaluated and analyzed for crystal morphology by means of micro-region X-ray diffraction in the same manner. Consequently as for the 100 micro-regions, the beta-type SiC had an average crystallite size of 2453 nm (maximum: 4021 nm, minimum: 1260 nm), and the alpha-type SiC had an average crystallite size of 3064 nm (maximum: 5026 nm, minimum: 1491 nm).

### Example 6

In the same manner as Example 1 except for using an alumina fiber bundle consisting of 1000 continuous monofilaments (diameter: 7 micrometers) in place of the PAN-type carbon fiber bundle consisting of 1000 continuous monofilaments (diameter: 7 micrometers) and using the SiC powder (specific surface area: 18 m²/g, average particle size: 0.31 micrometer) having an alpha-type crystal structure, two plates of each 40 mm long by 30 mm wide by 1 mm thick of SiC matrix composite material were obtained.

The resulting SiC matrix composite material was comprised of 60% by volume of SiC matrix, 22% by volume of the alumina fiber, and 18% by volume of porosity.

The two pieces of the SiC matrix composite material were subjected to 3-point bending strength test; consequently the bending strength was 930 MPa in average. Furthermore, the fracture toughness value of the SiC matrix composite material was 16 MPa·m^{1/2} based on the 3-point bending strength test.

Then in a similar manner to Example 1, the SiC matrix composite material was cut in random directions to prepare 10 cross-sections thereof with a surface roughness of no greater than 2 micrometers.

These cross-sections were evaluated and analyzed for crystal morphology means of micro-region X-ray diffraction in the same manner as Example 1 using a collimator with a pore diameter of 30 micrometers.

As a result, alpha-type SiC of from 10% to 90% by volume and beta-type SiC of from 90% to 10% by volume were detected at all 100 micro-regions of the SiC matrix, the mean content of the alpha-type SiC was 51% by volume (maximum: 81% by volume, minimum: 31% by volume), and the mean content of the beta-type SiC was 49% by volume (maximum: 69% by volume, minimum: 19% by volume).

As for the 100 micro-regions also, the beta-type SiC had an average crystallite size of 192 nm (maximum: 282 nm, minimum: 121 nm), and the alpha-type SiC had an average crystallite size of 88 nm (maximum: 178 nm, minimum: 47 nm).

The evaluation results of the SiC matrix composites in Examples and Comparative Examples are summarily shown in Table 1.

TABLE 1

| | | | | | | α-SiC | β-SiC | β-SiC | 3-Point | |
|---|---|---|---|---|---|---|---|---|---|---|
| | | | | α-SiC | β-SiC | crystallite | crystallite | crystallite size/ | bending | Fracture |
| | Matrix | Fiber | Porosity | vol. % | vol. % | size nm | size nm | α-SiC | strength | toughness |
| | vol. % | vol. % | vol. % | (average) | (average) | (average) | (average) | crystallite size | MPa | MPa · m½ |
| Ex. 1 | 39 | 45 | 16 | 28~74 | 26~72 | 51~145 | 110~148 | 2.53 | 980 | 18 |
| | | | | (av. 45) | (av. 55) | (av. 92) | (av. 233) | | | |
| Ex. 2 | 38 | 45 | 17 | 23~79 | 21~67 | 41~146 | 141~502 | 2.91 | 990 | 17 |
| | | | | (av. 47) | (av. 53) | (av. 108) | (av. 314) | | | |
| Ex. 3 | 41 | 45 | 14 | 25~81 | 19~75 | 39~181 | 78~332 | 2.74 | 1020 | 19 |
| | | | | (av. 48) | (av. 52) | (av. 92) | (av. 252) | | | |
| Ex. 4 | 33 | 50 | 17 | 29~81 | 19~71 | 128~310 | 104~595 | 2.25 | 920 | 20 |
| | | | | (av. 56) | (av. 44) | (av. 195) | (av. 439) | | | |
| Ex. 5 | 53 | 31 | 16 | 12~63 | 37~88 | 106~302 | 89~435 | 2.13 | 960 | 17 |
| | | | | (av. 39) | (av. 61) | (av. 172) | (av. 366) | | | |
| Ex. 6 | 60 | 22 | 18 | 31~81 | 19~69 | 47~178 | 121~282 | 2.18 | 930 | 16 |
| | | | | (av. 51) | (av. 49) | (av. 88) | (av. 192) | | | |
| Com. | 53 | 29 | 18 | — | 100* | — | 89~610 | — | 910 | 12 |
| Ex. 1 | | | | | | | (av. 430) | | | |
| Com. | 52 | 33 | 15 | 35~100* | 0*~65 | 425~1550 | 0*~210 | 0.18* | 890 | 11 |
| Ex. 2 | | | | (av. 55) | (av. 45) | (av. 880*) | (av. 155) | | | |
| Com. | 41 | 34 | 25* | 9~100* | 0*~91 | 504~2050 | 141~471 | 0.32* | 900 | 10 |
| Ex. 3 | | | | (av. 44) | (av. 56) | (av. 991*) | (av. 313) | | | |
| Com. | 41 | 47 | 12 | — | 100* | — | 589~2610 | — | 760 | 7 |
| Ex. 4 | | | | | | | (av. 1892) | | | |

The results in Table 1 demonstrate that preferably alpha-type SiC of from 12% to 81% by volume and beta-type SiC of from 19% to 88% by volume are detected at cross-sections of SiC matrix by micro-region X-ray diffraction with an X-ray beam diameter of no greater than 300 micrometers (including Examples 1 to 3, and 5); and more preferably the ratio of an average crystallite size of beta-type SiC to an average crystallite size of alpha-type SiC is in the range between 2.13 and 2.84 (including Examples 1 to 3).

### INDUSTRIAL APPLICABILITY

There is provided a composite material, where SiC matrix with excellent heat resistance and heat resistant fibers with high strength are combined, thus exhibiting remarkably excellent properties such as strength and toughness under high temperatures. This composite material is believed to present superior properties, as structural material such as of aerospace engines and power generation gas turbines, and to remarkably improve fuel economy and/or thermal efficiency thereof.

### CODE

1: preform
2: vacuum chamber
3: table
4: passage
5: valve
6: heater
7: silicon oxide
8: pan container

1. A SiC matrix composite material, comprising a SiC matrix and heat-resistant long fiber,
wherein the SiC matrix comprises both of alpha-type SiC and beta-type SiC, and the alpha-type SiC and the beta-type SiC are detected by micro-region X-ray diffraction with an X-ray beam diameter of no greater than 300 micrometers substantially at every region of every cross-section of the SiC matrix,
the beta-type SiC has an average crystallite size that is no greater than 500 nm and greater than an average crystallite size of the alpha-type SiC, and
the SiC matrix composite material has a porosity of no greater than 20% by volume.

2. The SiC matrix composite material according to claim 1, wherein the alpha-type SiC of from 12% to 81% by volume and the beta-type SiC of from 19% to 88% by volume are detected substantially at every cross-section of the SiC matrix by the micro-region X-ray diffraction with the X-ray beam diameter of no greater than 300 micrometers.

3. The SiC matrix composite material according to claim 2, wherein a ratio of an average crystallite size of the beta-type SiC to an average crystallite size of the alpha-type SiC is in a range of from 2.13 to 2.84.

4. The SiC matrix composite material according to claim 1, wherein the alpha-type SiC has an average crystallite size of from 5 to 200 nm, the beta-type SiC has an average crystallite size of from 10 to 500 nm, the average crystallite size of the beta-type SiC is no less than two times of the average crystallite size of the alpha-type SiC, and the SiC matrix composite material has a porosity of no greater than 15% by volume.

5. The SiC matrix composite material according to claim 1, wherein the alpha-type SiC comprises a polytype of 4H, 6H and/or 15R, and the beta-type SiC comprises a polytype of 3C.

6. The SiC matrix composite material according to claim 1, wherein the heat-resistant long fiber is at least one type selected from a group of SiC long fiber, carbon long fiber, and alumina long fiber.
